(19) United States
(12) Patent Application Publication
(10) Pub. No.: US 2026/0093408 A1
(43) Pub. Date: Apr. 2, 2026

(54) STORAGE MANAGEMENT METHOD AND STORAGE MANAGEMENT DEVICE

(71) Applicant: SigmaStar Technology Ltd., Xiamen (CN)

(72) Inventors: Yan Qing WANG, Xiamen (CN); Xin ZHANG, Xiamen (CN); Yan Xiong WU, Xiamen (CN)

(21) Appl. No.: 19/272,000

(22) Filed: Jul. 17, 2025

(30) Foreign Application Priority Data
Sep. 27, 2024 (CN) 202411364282.3

(51) Int. Cl. G06F 3/06

(52) U.S. Cl. CPC G06F 3/064; G06F 3/0613; G06F 3/0652; G06F 3/0659; G06F 3/0679

(57) ABSTRACT

A storage management method accesses a storage apparatus including multiple blocks by a file system. The file system includes multiple logical blocks mapped to the blocks, and each of the logical blocks has a logical block number. The storage management method includes: receiving a first storage request to store first data of a first type; dividing a first logical block of the logical blocks into multiple logical sub-blocks in response to the first storage request; allocating a first logical sub-block of the logical sub-blocks to the first data; and generating a first logical identification code mapped to the first logical sub-block so as to record in the first logical identification code a status flag of the first type corresponding to a first value, a logical sub-block number of the first logical sub-block, and a logical block number of the first logical block.

This application claims the benefit of China application Serial No. CN202411364282.3, filed on Sep. 27, 2024, the subject matter of which is incorporated herein by reference.

### BACKGROUND OF THE INVENTION

### Field of the Invention

The present application relates to a storage management method and a storage management device, and more particularly to a storage management method and a storage management device that divide logical blocks into logical sub-blocks for efficient storage.

### Description of the Related Art

An embedded electronic device uses a Serial Peripheral Interface (SPI) NAND flash including a plurality of erasable blocks as an external large-capacity memory, so as to store data such as system mapping files and file systems. A file system stores data in a unit of blocks. With such allocation means, even a file having a small data size nonetheless occupies one entire block, meaning that such allocation means yields a reduced space utilization rate.

### SUMMARY OF THE INVENTION

In view of the issues of the prior art, it is an object of the present application to provide a storage management method and a storage management device so as to improve the issue of the prior art.

In some embodiments, the storage management method accesses a storage apparatus by a file system, the storage apparatus includes a plurality of blocks, the file system includes a plurality of logical blocks mapped to the plurality of blocks, and each of the plurality of logical blocks has a logical block number. The storage management method includes: receiving a first storage request to store first data of a first type; dividing a first logical block of the plurality of logical blocks into a plurality of logical sub-blocks in response to the first storage request; allocating a first logical sub-block of the plurality of logical sub-blocks to the first data; generating a first logical identification code mapped to the first logical sub-block so as to record in the first logical identification code a status flag of the first type corresponding to a first value, a logical sub-block number of the first logical sub-block, and a logical block number of the first logical block; receiving a second storage request to store second data of a second type; allocating a second logical block of the plurality of logical blocks to the second data in response to the second storage request; and generating a second logical identification code mapped to the second logical block so as to record in the second logical identification code a status flag of the second type corresponding to a second value, a predetermined logical sub-block number and a logical block number of the second logical block.

In some embodiments, the storage management device accesses a storage apparatus by a file system, the storage apparatus includes a plurality of blocks, the file system includes a plurality of logical blocks mapped to the plurality of blocks, and each of the plurality of logical blocks has a logical block number. The storage management device includes a processor, which performs, according to at least one instruction in a memory, the steps of: receiving a first storage request to store first data of a first type; dividing a first logical block of the plurality of logical blocks into a plurality of logical sub-blocks in response to the first storage request; allocating a first logical sub-block of the plurality of logical sub-blocks to the first data; generating a first logical identification code mapped to the first logical sub-block so as to record in the first logical identification code a status flag of the first type corresponding to a first value, a logical sub-block number of the first logical sub-block, and a logical block number of the first logical block; receiving a second storage request to store second data of a second type; allocating a second logical block of the plurality of logical blocks to the second data in response to the second storage request; and generating a second logical identification code mapped to the second logical block so as to record in the second logical identification code a status flag of the second type corresponding to a second value, a predetermined logical sub-block number and a logical block number of the second logical block.

The storage management method and the storage management device of the present invention further divide a logical block into a plurality of logical sub-blocks, and store multiple sets of data having smaller data sizes by multiple logical sub-blocks of the logical block. Thus, if the same logical block contains any available logical sub-block, the space of the available logical sub-block is to be allocated to other data for further use. Therefore, the storage management method and the storage management device of the present invention efficiently allocate storage spaces to prevent any storage space waste.

Features, implementations and effects of the present application are described in detail in preferred embodiments with the accompanying drawings below.

### BRIEF DESCRIPTION OF THE DRAWINGS

To better describe the technical solution of the embodiments of the present application, drawings involved in the description of the embodiments are introduced below. It is apparent that, the drawings in the description below represent merely some embodiments of the present application, and other drawings apart from these drawings may also be obtained by a person skilled in the art without involving inventive skills.

FIG. 1 is a schematic diagram of a data management device and a memory according to some embodiments of the present application;

FIG. 2 is a flowchart of a storage management method according to some embodiments of the present application;

FIG. 3 is a schematic diagram of a relationship between logical blocks and logical sub-blocks according to some embodiments of the present application;

FIG. 4 is a schematic diagram of an allocation relationship between logical sub-blocks and data according to some embodiments of the present application;

FIG. 5 is a schematic diagram of logical blocks, logical sub-blocks and logical identification codes according to some embodiments of the present application;

FIG. 6 is a flowchart of allocating logical blocks and logical sub-blocks according to some embodiments of the present application;

FIG. 7 is a flowchart of reading from logical blocks and logical sub-blocks according to some embodiments of the present application;

FIG. 8 is a flowchart of writing to logical blocks and logical sub-blocks according to some embodiments of the present application;

FIG. 9 is a flowchart of erasing logical blocks and logical sub-blocks according to some embodiments of the present application; and

FIG. 10 is a schematic diagram of a logical block and logical sub-blocks according to some embodiments of the present application.

### DETAILED DESCRIPTION OF THE INVENTION

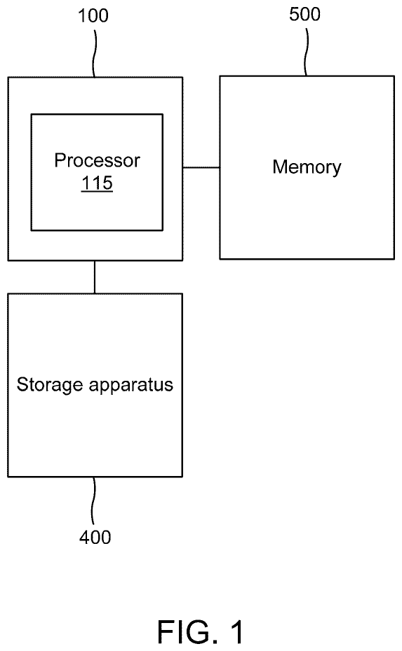

FIG. 1 shows a schematic diagram of a data management device 100, a storage apparatus 400 and a memory 500 according to some embodiments of the present application. The storage management device 100 is connected to the storage apparatus 400 and the memory 500, and includes a processor 115. The storage apparatus 400 may be a non-flash memory (a NAND flash memory), and the memory 500 may be a dynamic random access memory (DRAM)). The memory 500 has a plurality of program instructions and/or program codes stored therein, and the storage management device 100 implements its functions by executing these program instructions and/or program codes. In some embodiments, the storage management device 100 may be a control chip.

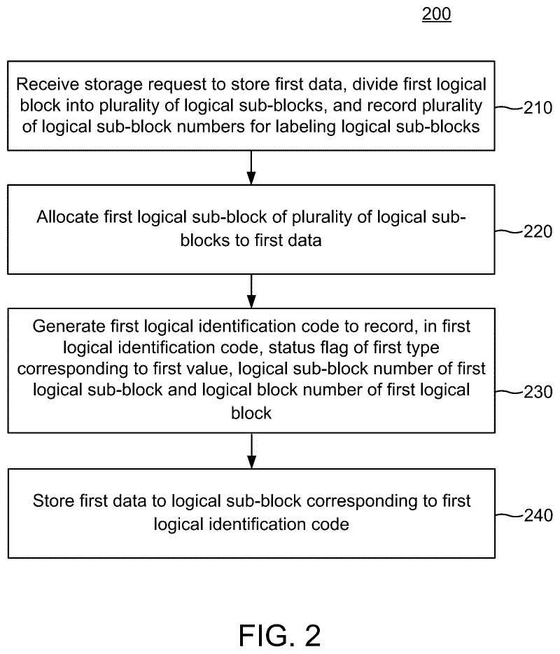

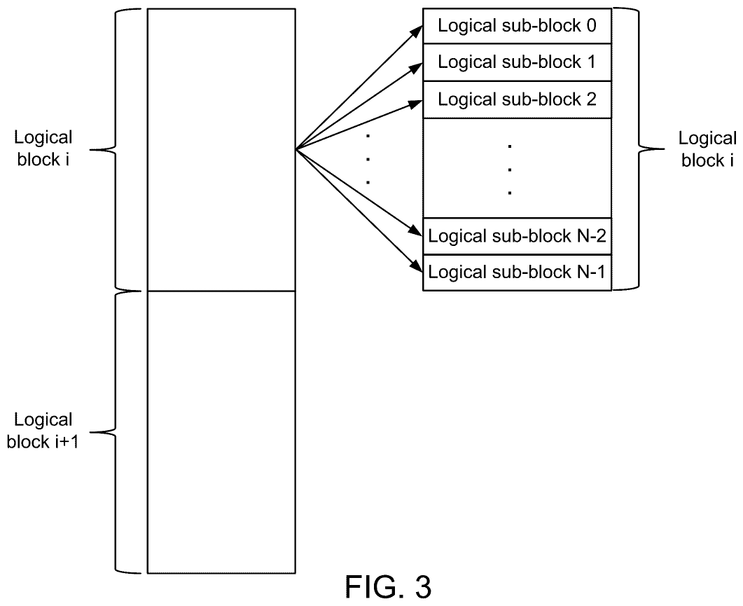

Operations of the storage management device 100 are described in detailed in combination with FIG. 2 below. FIG. 2 shows a flowchart of a storage management method 200 according to some embodiments of the present application. The storage management method 200 accesses the storage apparatus 400 by a file system. The storage apparatus 400 includes a plurality of blocks, each of which including a plurality of pages. The pages are a basic operation unit for reading from or writing to the storage apparatus 400, and the blocks are a basic operation unit for erasing the storage apparatus 400. Referring to FIG. 3, the file system includes a plurality of logical blocks i and i+1 mapped to a plurality of blocks, and each of the plurality of logical blocks i and i+1 has a logical block number (BN).

In step 210, a storage request is received to store first data of a first type, a first logical block of the plurality of logical blocks is divided into a plurality of logical sub-blocks, and a plurality of sub-block numbers (SN) for labeling these logical sub-blocks are recorded. Referring to FIG. 3, the processor 115 may divide an available logical block i of the plurality of logical blocks i and i+1 into a plurality of logical sub-blocks 0 to N−1, each of which corresponding to pages of a predetermined number (for example, 1). When one logical block is divided into a plurality of logical sub-blocks, the processor 115 further records a plurality of usage flags for labeling usage conditions of the individual logical sub-blocks, for example, indicating that the logical sub-block is in an available state by a first usage flag, and indicating that the logical sub-block is in an occupied state by a second usage flag. It can be understood that each logical block is also recorded with a corresponding usage flag. Thus, the usage flag of the logical block or the logical sub-block can be updated according to a current usage condition of the logical block or the logical sub-block, and the current usage condition of the logical block or the logical sub-block can be learned by looking up the usage flag.

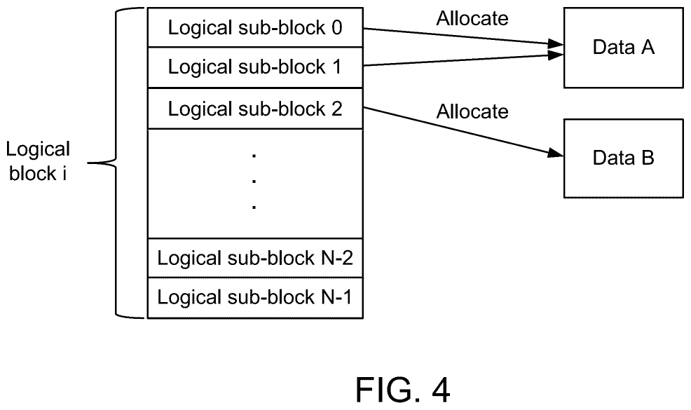

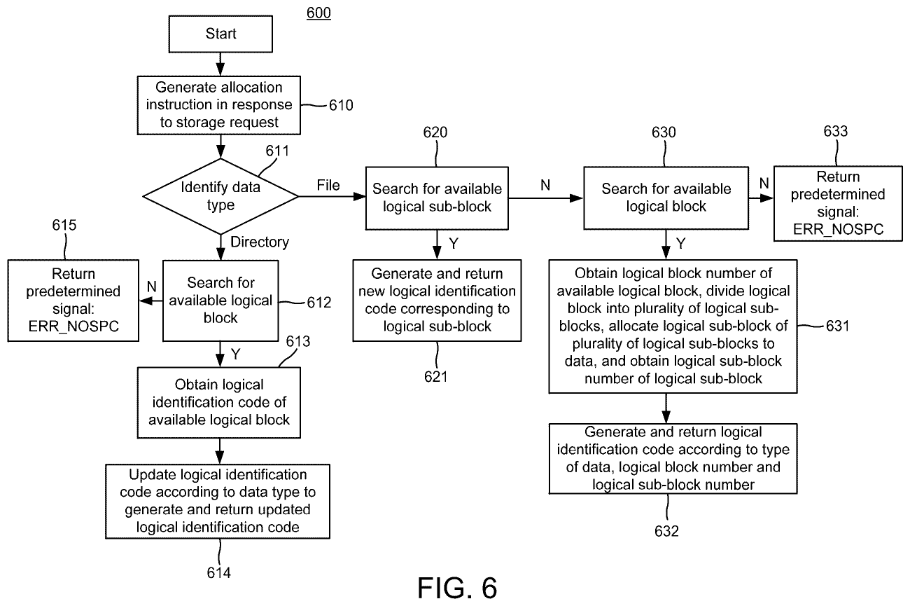

In step 220, a first logical sub-block of the plurality of logical sub-blocks is allocated to the first data. Referring to FIG. 4, the processor 115 allocates a logical sub-block 0 and a logical sub-block 1 of the logical sub-block i to first data A according to the size of the first data A (with related details to be described in combination with FIG. 6 below). Thus, the first data A can be stored to the pages corresponding to the logical sub-block 0 and the logical sub-block 1. In some embodiments, the first data A may be a file, for example, a file in a littlefs file system. Further, when the first logical sub-block is allocated to the first data, the processor 115 updates the usage flag of the first logical sub-block according to the allocation, for example, updating the first usage flag to the second usage flag.

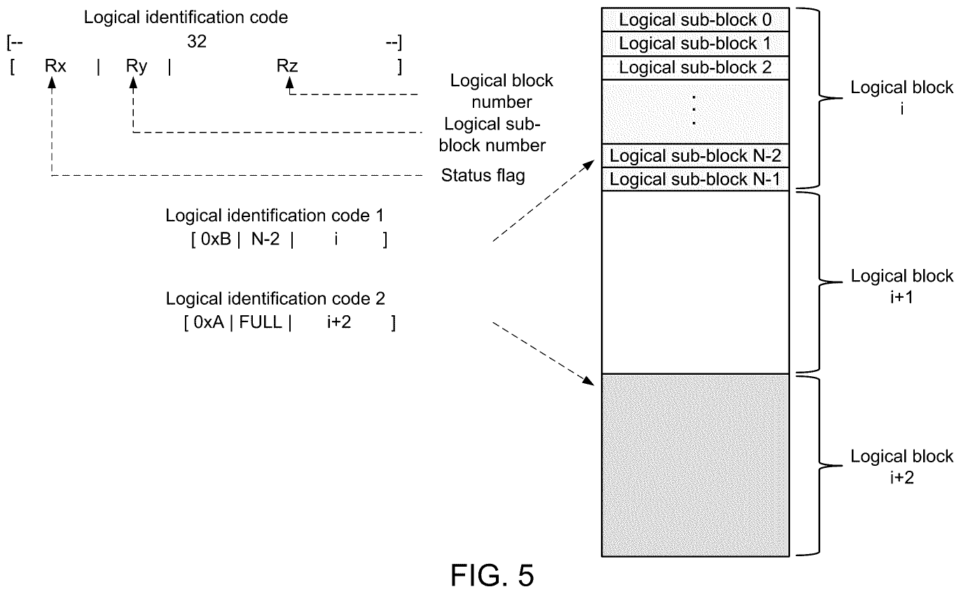

In step 230, a first logical identification code mapped to the first logical sub-block is generated so as to record, in the first logical identification code, a status flag of the first type corresponding to a first value, a logical sub-block number of the first logical sub-block, and a logical block number of the first logical block. In this embodiment, the logical identification code occupies a predetermined number of bits, wherein the first number of bits are for recording the status flag of the corresponding logical block or the logical sub-block, the second number of bits are for recording the logical sub-block number, the third number of bits are for recording the logical block number, and the sum of the first, second and third numbers of bits is equal to the predetermined number of bits. Referring to FIG. 5, in one embodiment, as shown on the upper-left corner, the predetermined number of bits is 32, that is, a logical identification code is recorded by 32 bits. An Rx section of the logical identification code is for recording the status flag of the logical block/logical sub-block, an Ry section of the logical identification code is for recording the logical sub-block number, and an Rz section of the logical identification code is for recording the logical block number. By recording in detail the relationships among the statuses of the logical blocks/logical sub-blocks, the logical sub-blocks and the logical blocks by the logical identification code above, the present application efficiently allocates storage spaces for subsequent operations such as writing, reading and erasing.

In one embodiment, for other logical sub-blocks not yet having data stored therein of the logical block, the processor 115 may also generate multiple corresponding logical identification codes, and the Rx sections of the corresponding logical identification codes then record the status flags as a predetermined flag such as FREE. The processor 115 further records all logical identification codes of the current file system in a form for further management.

In step 240, the first data is stored to the logical sub-block corresponding to the first identification code. Moreover, after the first data is stored to the logical sub-block, the usage flag of this logical sub-block is updated accordingly. It can be understood that, in the present application, storing data to a logical block or a logical sub-block is storing data to a corresponding block of the logical block or a corresponding page of the logical sub-block.

The file system of the present application assigns a corresponding logical identification code to each logical block or logical sub-block, and related information of the logical block or logical sub-block can be obtained according to the logical identification code. An example of correspondence between the status of a logical block or a logical sub-block and a status flag in a logical identification code is shown in Table-1 below, and thus the status of a logical block or a logical sub-block can be learned from the status flag of the logical identification code.

Table-1 shows a table of the flag of a data type in the logical identification code and the meaning thereof.

| Flag of Rx | | |
|---|---|---|
| section of | | |
| logical | Corresponding | |
| identification | data | |
| code | type/status | Meaning |
| 0xA | FREE | Logical block or logical sub-block has no |
| | | stored data |
| 0xB | CTZ | Logical sub-block can store file data |
| 0xC | METADATA | Logical sub-block can store directory data |
| 0xD | ABANDAN | Directory data stored in logical block is in |
| | | invalid and unerased state |
| 0xE | GC | File data stored in logical sub-block is in |
| | | invalid and unerased state |

In some embodiments, in order to provide the file system and the littlefs file system of the present application with certain level of inheritance so as to directly use certain functions provided by littlefs, the predetermined number of bits of the present application can be configured to be 32 bits. Thus, the storage structure of the littlefs file system can be applied in the present application, and only the meaning represented by a uint32_t type field used for recording logical identification codes in the storage structure of the littlefs file system needs to be adjusted. Taking the contents shown in FIG. 5 for example, the numbers of bits occupied by the Rx section, the Ry section and the Rz section are Bx, By and Bz, respectively. The adjustment above can be implemented given that Bx, By and Bz satisfy the conditions below:

$$0 \leq Bx \leq 4 \qquad Condition 1$$

$$0 \leq By \leq 8 \qquad Condition 2$$

$$20 \leq Bz \leq 32 \qquad Condition 3$$

$$Bx + By + Bz = 32 \qquad Condition 4$$

Assuming that Bx is 0, By is 0 and Bz is 32, the storage structure of the present application is equivalent to the storage structure of the littlefs file system; in other words, all of the 32 bits of the storage structure of the littlefs file system are for representing the value of a logical identification code (block ID), and the addressing space is 2³².

Referring to Condition 4, once the numbers of bits respectively occupied by the Rx section and the Ry section are determined, the number of bits occupied by the Rz section can also be determined. It should be noted that the present application is not limited to the embodiment above, and the embodiment is merely an example for describing one of implementation forms of the present application. In other embodiments, other appropriate means for configuring bits of a logical identification code can also be used, depending on actual requirements.

Referring to a logical identification code 1 in FIG. 5, assuming that the data type in a logical sub-block N−2 of the logical block i is a file (since the file system of the present application uses a CTZ skip-list data structure to record information of the file system, the data is referred to as file data of a CTZ type in brief), the processor 115 may generate the logical identification code 1 according to the logical block i, the logical sub-block N−2 and the file type in the logical sub-block N−2, and record, in the logical identification code 1, a status flag 0×B (representing the file data of the CTZ type), the logical sub-block number N−2 of the logical sub-block N−2, and the logical block number i of the logical block i.

The logical sub-block number represents a corresponding position of a logical sub-block in a corresponding logical block, and corresponds to one or more pages of a block mapped to the logical block. In other words, according to the logical sub-block and the address mapping relationship between the corresponding logical block thereof and blocks, a page corresponding to the logical sub-block number can be addressed.

Referring to FIG. 4, if the logical sub-blocks 0 and 1 of the logical block i are allocated to the first data A (which is a file of a CTZ type), the processor 115 may accordingly generate a first logical identification code corresponding to the logical sub-block 0 and a second logical identification code corresponding to the logical sub-block 1, respectively, so as to record the status flag 0×B, the logical sub-block number 0 of the logical sub-block 0 and the logical block number i of the logical block i in the first logical identification code, and record the status flag 0×B, the logical sub-block number 1 of the logical sub-block 1 and the logical block number i of the logical block i in the second logical identification code. If the logical sub-block 2 of the logical block i is allocated to the data B (which is a file of the CTZ type), the processor 115 may accordingly generate a third logical identification code corresponding to the logical sub-block 2, so as to record the status flag 0×B, the logical sub-block number 2 of the logical sub-block 2 and the logical block number i of the logical block i in the third logical identification code. Once the first data A and the data B are stored to the logical blocks 0, 1 and 2, the processor 115 updates the usage flags of the logical sub-blocks 0, 1 and 2.

Refer to the logical identification code 2 in FIG. 5. Assuming that the type of data to be stored is a directory, the present application may allocate the entire logical block i+2 of the plurality of logical blocks i to i+2 to the data above and generate a logical identification code (for example, a logical identification code 2), so as to record a status flag 0×C (which corresponds to metadata, since the present file system uses metadata to record directory data), a logical sub-block number having a default value, and a logical block number i+2 of the logical block i+2 in the logical identification code 2. It should be noted that, for the directory data, the current file system uses one or more sets of metadata to record related information of a directory (for example, information including a file and sub-directories under this directory), and the present application allocates an entire logical block to one set of metadata so as to store the directory data to the block corresponding to the logical block. Thus, the logical sub-block number in the logical identification code 2 only needs to record a default value (for example, FULL).

In some embodiments, when data becomes invalid, for example, when data in a logical sub-block becomes invalid, the processor 115 accordingly updates the logical identification code corresponding to the logical block or the logical sub-block storing the data so as to record in the updated logical identification code the information that the data has become invalid. For example, the processor 115 may update the status flag of the Rx section of the logical identification code to a predetermined status flag such as 0×D or 0×E (which corresponds to ABANDAN or GC). Thus, when the predetermined status flag in the Rx of the logical identification code is identified, if the logical identification code corresponds to a logical sub-block, read or write operations cannot be performed on the logical sub-block; if the logical identification code corresponds to a logical block, only erase operations can be performed on the logical block.

As described above, in the present application, by recording in detail the relationships among the storage status of data, logical sub-blocks and logical blocks, the novel logical identification code of the present application can be extremely beneficial for related operations such as read, write and erase operations.

FIG. 6 shows a flowchart of a process 600 of allocating logical blocks and logical sub-blocks according to some embodiments of the present application. It should be noted that, FIG. 6 is a detailed flowchart of step 220 in FIG. 6 according to an embodiment. Specifically, in step 610, when the storage request is received to write the data to the storage apparatus, an allocation instruction is generated according to the storage request to allocate a logical block or a logical sub-block to the data. The storage request is generated in response to a user operation, and the allocation instruction is generated according to the storage request. Moreover, whether one or more allocation instructions are to be generated according to one storage request is dependent on the size of the data to be written to the storage apparatus. In continuation of FIG. 4, the first data A needs to occupy two logical sub-blocks 0 and 1, two allocation instructions are generated according to the storage request for storing the first data A, and one logical sub-block is allocated to the first data A in response to each of the allocation instructions. That is, only one logical sub-block or one logical block (depending on the type of data) is allocated for each allocation instruction.

In step 611, the type of the data is identified. Specifically, the storage request includes information of the data to be stored, such as the type and the size of the data, and the type of the data can be identified according to the information of the data. If the type of the data is a directory, step 612 is performed; if the type of the data is a file, step 620 is performed. In step 612, a search is performed for available logical blocks, for example, erased logical blocks. Specifically, the processor 115 may search for available logical blocks according to a logical identification code having a status flag set as the predetermined status flag (for example, 0×A) or a logical block having a usage flag set as the first usage flag. If an available logical block is searched, step 613 is performed; if not, step 615 is performed. In step 613, the logical identification code of the available logical block, for example, BLOCK_ID (0×A, 0, X), is obtained. In step 614, the logical identification code is updated according to the type of the data to generate an updated logical identification code, and the updated logical identification code, for example, BLOCK_ID (0×C, FULL, X), is returned, so as to allocate the entire available logical block X to the data. The updated logical identification code is recorded with status flag (0×C) corresponding to the data type (metadata), the logical sub-block number in a default value, for example, FULL, and the logical block number, for example, X. In step 615, a predetermined signal, for example, a no-response error signal ERR_NOSPC, is returned to indicate that no available logical block can be allocated to the data.

In step 620, a search is performed for available logical sub-blocks. The details of step 620 can be referred from step 612. If an available logical sub-block is searched, step 621 is performed; if not, step 630 is performed. In step 621, the logical identification code corresponding to the logical sub-block is generated, and the logical identification code is returned. In one embodiment, the status flag in the existing logical identification code of the logical sub-block can be updated according to the type of the data to generate and return a new logical identification code. For example, assuming the logical identification code of the logical sub-block is BLOCK_ID (FREE, Y2, Y1), the logical identification code is updated to BLOCK_ID (CTZ, Y2, Y1) according to the type of the data which is a file and is returned, so as to allocate the logical sub-block Y2 of the logical block Y1 to the data. In another embodiment, the logical identification code BLOCK_ID (CTZ, Y2, Y1) of the logical sub-block can be newly generated according to the type of the data, the block number Y2 of the logical sub-block and the block number Y1 of the corresponding logical block. Then, the logical identification code BLOCK_ID (CTZ, Y2, Y1) is used to substitute for the original logical identification code BLOCK_ID (FREE, Y2, Y1) of the logical sub-block.

In step 630, a search is performed for available logical blocks, for example, erased and hence available logical blocks. The details of step 630 can be referred from the details of step 612. If an available logical block is found from the search, step 631 is performed; if not, step 633 is performed. In step 631, the logical block number Z1 of the available logical block is obtained, the logical block is divided into a plurality of logical sub-blocks, one logical sub-block of the plurality of logical sub-blocks is allocated to the data, and the logical sub-block number Z2 of the logical sub-block is obtained. In step 632, a logical identification code, for example, BLOCK_ID (CTZ, Z2, Z1), is generated according to the type of the data, the logical block number Z1 and the logical sub-block number Z2, and the logical identification code is returned to accordingly allocate the logical sub-block Z2 of the logical block Z1 to the data. In step 633, a predetermined signal, for example, a no-response error signal ERR_NOSPC, is returned to indicate that no available logical block can be allocated to the data.

Moreover, in steps 614, 621 and 632 when a logical block or a logical sub-block is allocated to the data, the processor 115 correspondingly records or updates the usage flag of the logical block or the logical sub-block.

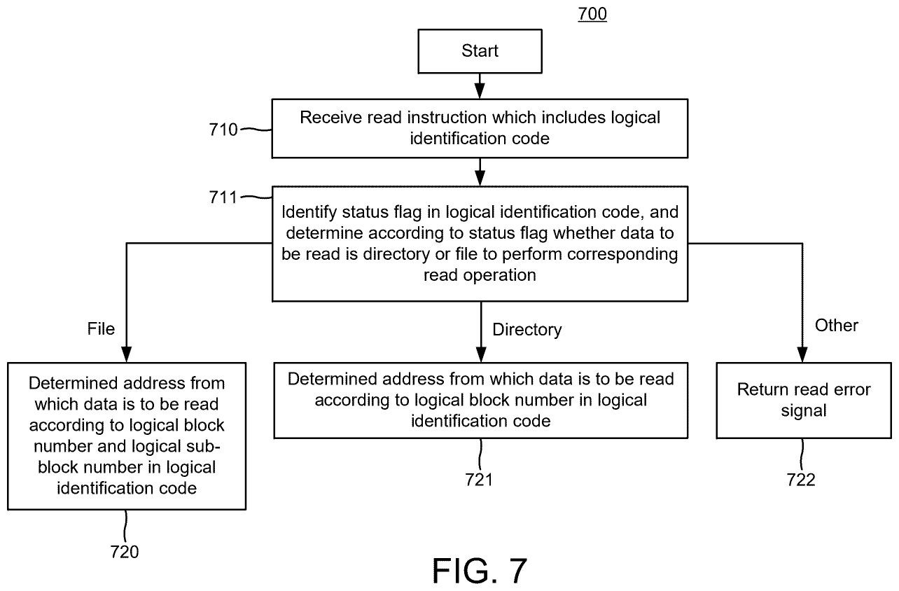

FIG. 7 shows a flowchart of a process 700 of reading from logical blocks and sub-logical blocks according to some embodiments of the present application. The process 700 includes step 710 of receiving a read request to read data, wherein the reading request includes a logical identification code. In another embodiment, the read request further includes parameters such as an address offset and a data size of data to be read. In step 711, the status flag in the logical identification code is identified, and it is determined according to the status flag whether data to be read is a directory or a file so as to perform the corresponding read operation. Specifically, if the data to be read is a file (for example, when the status flag corresponding to CTZ is identified in the logical identification code), step 720 is performed; if the data is a directory (for example, the status flag corresponding to metadata is identified in the logical identification code), step 721 is performed; otherwise (that is, the type of the data to be read is neither a file nor a directory, for example, the status flag corresponding to CG is identified in the logical identification code), step 722 is performed. In step 720, an address, from which the data to be read, is determined according to the logical block number and the logical sub-block number in the logical identification code so as to read the data. Specifically, the processor 115 determines a starting address according to the logical block number, the logical sub-block number and the address offset in the read request. Further, the processor 115 also determines an ending address according to the data size in the read request. In practice, the processor 115 calls a read functions “read (block number, sub-block number*sub-block size+offset, size)” according to the identified logical block number (block number), logical sub-block number (sub-block number), size of each logical sub-block (sub-block size), address offset (offset) and data size (size), so as to read the data.

In step 721, the address, from which the data to be read, is determined according to the logical block number in the logical identification code so as to read the data. When the read request includes the address offset and the data size, the starting address for reading the data can be further determined according to the address offset and the ending address can be further determined according to the data size. Specifically, in practice, the read function “read (block number, offset, size)” is called according to the identified logical block number (block number), address offset (offset) and data size (size) so as to read the data. In step 722, a predetermined read error signal, for example, a no-valid data signal ERR_INVA, is returned to indicate that the read request cannot read the data.

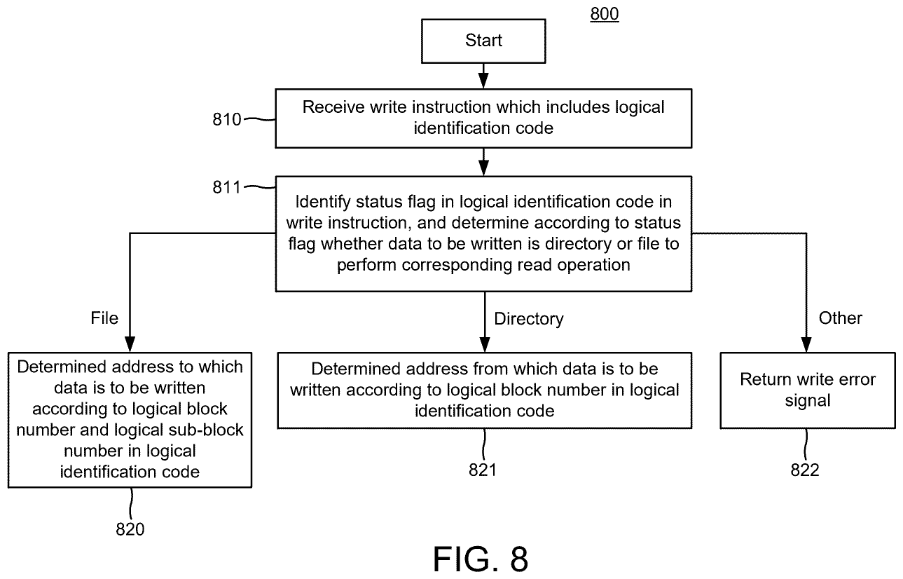

FIG. 8 shows a flowchart of a process 800 of writing to logical blocks and logical sub-blocks according to some embodiments of the present application. It should be noted that, FIG. 8 is a detailed flowchart of step 240 in FIG. 2 according to an embodiment.

In step 810, a write instruction is obtained to write data, wherein the write instruction includes a logical identification code. Specifically, the processor 115 generates a correspondingly write instruction after the logical identification code returned in one of steps 614, 621 and 631 is received. It should be understood that, once the write instruction is generated, then it can be obtained. Optionally, the write request further includes parameters such as an address offset and a data size of data to be written. In step 811, the status flag of the logical identification code in the write instruction is identified, and it is determined according to the status flag whether data to be written is a directory or a file so as to perform the corresponding write operation. Specifically, if the data to be written is a file, step 820 is performed; if the data to be written is a directory, step 821 is performed; otherwise, that is, the data to be written is neither a file nor a directory, step 822 is performed. In step 820, an address to which the data to be written is determined according to the logical block number and the logical sub-block number in the logical identification code. Optionally, a starting address for writing the data is further determined according to the address offset in the write instruction, and an ending address for writing the address is further determined according to the data size in the write instruction. In practice, a write functions “prog (block number, sub-block number*sub-block size+offset, size)” may be called according to the identified logical block number (block number), logical sub-block number (sub-block number), size of each logical sub-block (sub-block size), address offset (offset) and data size (size), so as to write the data to the corresponding logical sub-block.

In step 821, the address to which the data to be written is determined according to the logical block number in the logical identification code so as to write the data. When the write instruction includes the address offset, the starting address for writing the data is further determined according to the address offset, and the ending address for writing the address is further determined according to the data size in the write instruction. Specifically, in practice, a write function “prog (block number, offset, size)” may be called according to the identified logical block number (block number), address offset (offset) and data size (size), so as to write the data to the corresponding logical block. In step 822, a write error signal is returned to indicate that the data cannot be written to the corresponding logical block or the logical sub-block thereof according to the write instruction.

After the data is written, the processor 115 updates the corresponding logical identification code, for example, updating the status flag in the logical identification code and updating the usage flag of the corresponding logical block or logical sub-block.

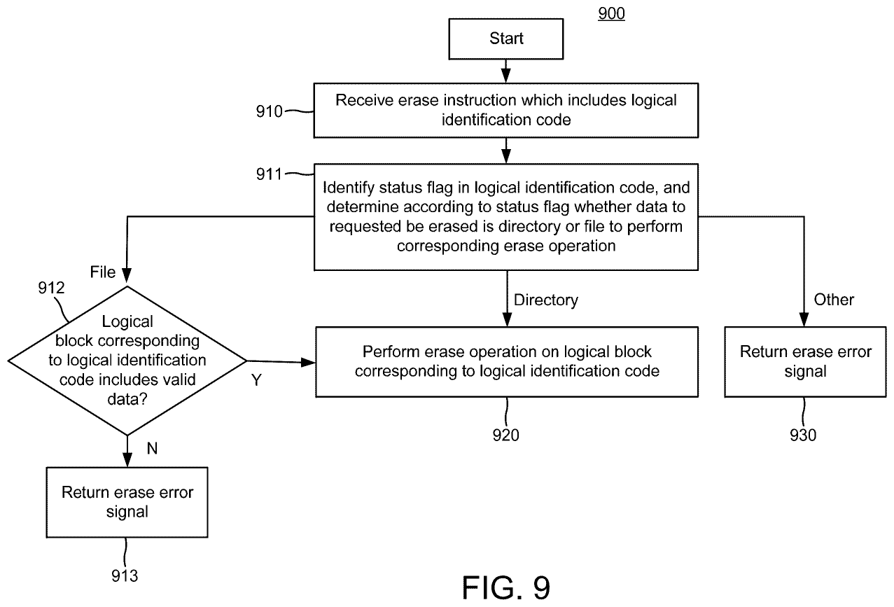

FIG. 9 shows a flowchart of a process 900 of erasing logical blocks according to some embodiments of the present application. As shown in the drawing, in step 910, an erase request is received to erase data. The erase request includes a logical block number. In step 911, the status flag in the logical identification code is identified, and it is determined according to the status flag whether data requested to be erased is a directory or a file so as to perform the corresponding erase operation. Specifically, if the data to be erased is a file, step 912 is performed; if the data to be erased is a directory, step 920 is performed; otherwise, that is, the data to be erased is neither a file nor a directory (for example, the status flag corresponding to FREE is identified in the logical identification code), step 930 is performed. In step 912, it is determined whether the logical block corresponding to the logical identification code includes valid data. Specifically, the logical block number in the logical identification code is determined, all logical identification codes including the logical block number are identified, and it is determined according to the corresponding status flags of all of the logical identification codes whether the logical block includes valid data. If the status flag of any one of the logical identification codes is in a predetermined value, for example, CTZ, it is determined that the logical block includes valid data. If so, step 913 is performed to return an erase error signal to indicate that the erase operation is not to be performed. That is, because valid data is stored in one of the remaining logical sub-blocks in the logical block where the logical identification code is located, the erase operation cannot be performed on the logical block.

In step 920, the erase operation is performed on the logical block corresponding to the logical identification code. Specifically, the logical block number may be obtained from the logical identification code included in the erase request, and an erase interface “erase (block number)” is called to erase the entire logical block, that is, performing the erase operation on the block corresponding to the logical block. If so, step 930 is performed to return an erase error signal to indicate that the erase operation cannot be performed. It can be understood that the erase error signals returned in steps 913 and 930 may be the same or different.

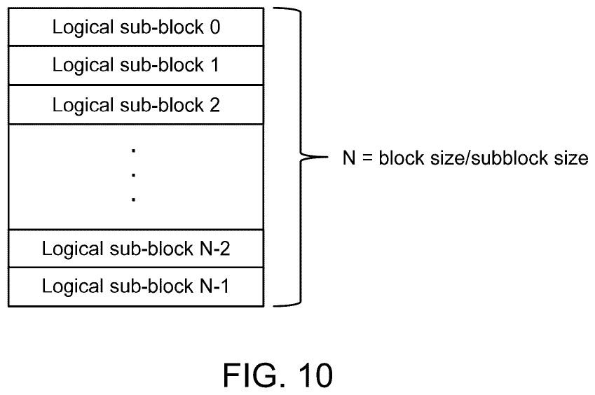

FIG. 10 shows a schematic diagram of a logical block and logical sub-blocks according to some embodiments of the present application. As shown in the drawing, the present application may configure the size of logical sub-blocks (for example, the size of a sub block (that is, sub-block size)), wherein the size of the logical sub-blocks may be an integer multiple of a write page size and a read page size, and may be integrally divided by the size of the logical block (for example, erase block size). The size of the logical sub-blocks (sub-block size) is recorded in the configuration file of the file system of the present application.

It should be noted that, the present application is not limited to the embodiments shown in FIG. 1 to FIG. 10, and these embodiments are merely examples of implementations of the present application. To better understand the technical contents of the present application, the scope of protection of the present application is to be accorded with the broadest interpretation of the appended claims. Without departing from the spirit of the present application, all modifications and variations made to the embodiments of the present application by a person skilled in the art are to be encompassed within the scope of protection of the present application.

In conclusion, the storage management method and the storage management device of the present invention further divide a logical block into a plurality of logical sub-blocks, and store multiple sets of data having smaller data sizes individually by multiple logical sub-blocks of the logical block. Thus, if the same logical block contains any available logical sub-block, the space of the logical sub-block is to be allocated to other data for further use. Therefore, the storage management method and the storage management device of the present invention efficiently allocate storage spaces to prevent any storage space waste.

Moreover, the logical block number is further configured in the storage management method and the storage management device of the present application. By recording in detail the statuses of the logical blocks or logical sub-blocks, the relationships between the logical sub-blocks and logical blocks by the logical identification code above, the present application efficiently allocates storage spaces for subsequent operations such as writing, reading and erasing.

While the present application has been described by way of example and in terms of the preferred embodiments, it is to be understood that the disclosure is not limited thereto. Various modifications made be made to the technical features of the present application by a person skilled in the art on the basis of the explicit or implicit disclosures of the present application. The scope of the appended claims of the present application therefore should be accorded with the broadest interpretation so as to encompass all such modifications.

What is claimed is:

1. A storage management method, accessing a storage apparatus by a file system, the storage apparatus comprising a plurality of blocks, the file system comprising a plurality of logical blocks mapped to the plurality of blocks, each of the plurality of logical blocks having a logical block number; the storage management method comprising:
receiving a first storage request to store first data of a first type;
dividing a first logical block of the plurality of logical blocks into a plurality of logical sub-blocks in response to the first storage request;
allocating a first logical sub-block of the plurality of logical sub-blocks to the first data;
generating a first logical identification code mapped to the first logical sub-block to record, in the first logical identification code, a status flag of the first type corresponding to a first value, a logical sub-block number of the first logical sub-block and a logical block number of the first logical block;
receiving a second storage request to store second data of a second type;
allocating a second logical block of the plurality of the logical blocks to the second data in response to the second storage request; and
generating a second logical identification code mapped to the second logical block to record, in the second logical identification code, a status flag of the second type corresponding to a second value, a predetermined logical sub-block number and a logical block number of the second logical block.

2. The storage management method according to claim 1, wherein the dividing of the first logical block of the plurality of logical blocks into the plurality of logical sub-blocks comprises:
generating and recording a plurality of logical sub-block numbers for labeling the plurality of logical sub-blocks.

3. The storage management method according to claim 1, wherein the dividing of the first logical block of the plurality of logical blocks into the plurality of logical sub-blocks comprises:
configuring a usage flag for each of the plurality of logical sub-blocks; and
when the first logical sub-block is allocated to the first data, updating the usage flag of the first logical sub-block.

4. The storage management method according to claim 3, further comprising:
searching for an available logical sub-block according to the usage flags of the plurality of logical sub-blocks in response to an allocation instruction generated according to the first storage request;
if the available logical sub-block is searched, generating a logical identification code according to the first type, the logical sub-block number of the available logical sub-block and the logical block number of the logical block corresponding to the available logical sub-block; and
if no available logical sub-block is searched, searching for a third logical block which is available from the plurality of logical blocks.

5. The storage management method according to claim 1, wherein the dividing of the first logical block of the plurality of logical blocks into the plurality of logical sub-blocks comprises:
generating a plurality of logical identification codes mapped to the plurality of logical sub-blocks, each of the plurality of logical identification codes having a status flag in an initial value;
searching for an available logical sub-block from the plurality of logical sub-blocks according to the status flags recorded in the logical identification codes of the plurality of logical sub-blocks in response to an allocation instruction generated according to the first storage request;
if the available logical sub-block is searched, updating the status flag in the initial value of the available logical sub-block to the status flag in the first value; and
if no available logical sub-block is searched, searching for a third logical block which is available from the plurality of logical blocks.

6. The storage management method according to claim 1, wherein the logical identification code occupies a predetermined number of bits; in the logical identification code, a first number of bits are for recording the status flag, a second number of bits are for recording the logical sub-block number and a third number of bits are for recording the logical block number, and a sum of the first, second and third numbers of bits is equal to or less than the predetermined number of bits.

7. The storage management method according to claim 1, further comprising:
receiving a read request to read data, the read request comprising a logical identification code;
identifying a status flag recorded in the logical identification code in the read request;
if the status flag is the first value, determining a read address according to the logical block number and the logical sub-block number in the logical identification code in the read request to accordingly read the data; and
if the status flag is the second value, determining a read address according to the logical block number of the logical identification code in the read request to accordingly read the data.

8. The storage management method according to claim 1, further comprising:
obtaining a write instruction which comprises a logical identification code;
identifying a status flag recorded in the logical identification code in the write request;
if the status flag is the first value, determining a write address according to the logical block number and the logical sub-block number in the logical identification code in the write request;
if the status flag is the second value, determining a write address according to the logical block number in the logical identification code in the write request.

9. The storage management method according to claim 1, further comprising:
obtaining an erase request which comprises a logical identification code;
identifying a status flag recorded in the logical identification code in the erase request;
if the status flag is a third value, obtaining all status flags mapped to the logical block number in the erase request, and when all of the status flags obtained are the third value, erasing data in the logical block corresponding to the logical identification code in the erase request; or
if the status flag is the second value, erasing data in the logical block corresponding to the logical identification code in the erase request.

10. A storage management device, accessing a storage apparatus by a file system, the storage apparatus comprising a plurality of blocks, the file system comprising a plurality of logical blocks mapped to the plurality of blocks, each of the plurality of logical blocks having a logical block number; the storage management device comprising:
a processor, performing, according to at least one instruction in a memory, steps of:
receiving a first storage request to store first data of a first type;
dividing a first logical block of the plurality of logical blocks into a plurality of logical sub-blocks in response to the first storage request;
allocating a first logical sub-block of the plurality of logical sub-blocks to the first data;
generating a first logical identification code mapped to the first logical sub-block to record, in the first logical identification code, a status flag of the first type corresponding to a first value, a logical sub-block number of the first logical sub-block and a logical block number of the first logical block;
receiving a second storage request to store second data of a second type;
allocating a second logical block of the plurality of the logical blocks to the second data in response to the second storage request; and
generating a second logical identification code mapped to the second logical block to record, in the second logical identification code, a status flag of the second type corresponding to a second value, a predetermined logical sub-block number and a logical block number of the second logical block.

11. The storage management device according to claim 10, wherein the step of the processor dividing the first logical block of the plurality of logical blocks into the plurality of logical sub-blocks comprises:
generating and recording a plurality of logical sub-block numbers for labeling the plurality of logical sub-blocks.

12. The storage management device according to claim 10, wherein the step of the processor dividing the first logical block of the plurality of logical blocks into the plurality of logical sub-blocks comprises:
configuring a usage flag for each of the plurality of logical sub-blocks; and
when the first logical sub-block is allocated to the first data, updating the usage flag of the first logical sub-block.

13. The storage management device according to claim 12, wherein the processor further performs, according to the at least one instruction in the memory, steps of:
searching for an available logical sub-block according to the usage flags of the plurality of logical sub-blocks in response to an allocation instruction generated according to the first storage request;
if the available logical sub-block is searched, generating a logical identification code according to the first type, the logical sub-block number of the available logical sub-block and the logical block number of the logical block corresponding to the available logical sub-block; and
if no available logical sub-block is searched, searching for a third logical block which is available from the plurality of logical blocks.

14. The storage management device according to claim 10, wherein the step of the processor dividing the first logical block of the plurality of logical blocks into the plurality of logical sub-blocks comprises:
generating a plurality of logical identification codes mapped to the plurality of logical sub-blocks, each of the plurality of logical identification codes having a status flag in an initial value;
searching for an available logical sub-block from the plurality of logical sub-blocks according to the status flags recorded in the logical identification codes of the plurality of logical sub-blocks in response to an allocation instruction generated according to the first storage request;
if the available logical sub-block is searched, updating the status flag in the initial value of the available logical sub-block to the status flag in the first value; and
if no available logical sub-block is searched, searching for a third logical block which is available from the plurality of logical blocks.

15. The storage management device according to claim 10, wherein the logical identification code occupies a predetermined number of bits, in the logical identification code, a first number of bits are for recording the status flag, a second number of bits are for recording the logical sub-block number and a third number of bits are for recording the logical block number, and a sum of the first, second and third numbers of bits is equal to or less than the predetermined number of bits.

16. The storage management device according to claim 10, wherein the processor further performs, according to the at least one instruction in the memory, steps of:
receiving a read request to read data, the read request comprising a logical identification code;
identifying a status flag recorded in the logical identification code in the read request;
if the status flag is the first value, determining a read address according to the logical block number and the logical sub-block number in the logical identification code in the read request to accordingly read the data; and
if the status flag is the second value, determining a read address according to the logical block number of the logical identification code in the read request to accordingly read the data.

17. The storage management device according to claim 10, wherein the processor further performs, according to the at least one instruction in the memory, steps of:
obtaining a write instruction which comprises a logical identification code;
identifying a status flag recorded in the logical identification code in the write request;
if the status flag is the first value, determining a write address according to the logical block number and the logical sub-block number in the logical identification code in the write request;
if the status flag is the second value, determining a write address according to the logical block number in the logical identification code in the write request.

18. The storage management device according to claim 10, wherein the processor further performs, according to the at least one instruction in the memory, steps of:
obtaining an erase request which comprises a logical identification code;
identifying a status flag recorded in the logical identification code in the erase request;
if the status flag is a third value, obtaining all status flags mapped to the logical block number in the erase request, and when all of the status flags obtained are the third value, erasing data in the logical block corresponding to the logical identification code in the erase request; or
if the status flag is the second value, erasing data in the logical block corresponding to the logical identification code in the erase request.
